(19) United States
(12) Patent Application Publication
(10) Pub. No.: US 2019/0013138 A1
(43) Pub. Date: Jan. 10, 2019

(54) CORE FOR TRANSFORMER OR REACTOR

(71) Applicant: HYOSUNG HEAVY INDUSTRIES CORPORATION, Seoul (KR)

(72) Inventors: Hyun Mo AHN, Busan (KR); Dong Joon SIM, Anyang-si (KR); Se Hee HAN, Seoul (KR)

(21) Appl. No.: 16/067,526

(22) PCT Filed: Dec. 30, 2016
(86) PCT No.: PCT/KR2016/015576

§ 371 Date: Jun. 29, 2018

(30) Foreign Application Priority Data
Dec. 30, 2015 (KR) 10-2015-0190321

(51) Int. Cl. H01F 27/26; H01F 27/28; H01F 41/02

(52) U.S. Cl. CPC H01F 27/263; H01F 41/0233; H01F 27/28

(57) ABSTRACT

Provided is a core for a transformer or a reactor. The core according to the present invention comprises: a first leg (10), a second leg (12), and a third leg (14), which are made of widthwise rolled steel plates (11); a first yoke (16) for connecting one end of the legs (10, 12, 14) so as for a magnetic flux to pass therethrough; and a second yoke (18) for connecting the other end of the legs (10, 12, 14) so as for a magnetic flux to pass therethrough. The first yoke (16) and the second yoke (18) are made using lengthwise rolled steel plates (17). The first leg (10) has a first coil (10′) wound therearound, and the second leg (12) has a second coil (12′) wound therearound, and the third leg (14) has a third coil (14′) wound therearound. As such, the present invention can relatively increase an overall magnetic reluctance value and thus has the advantage of preventing the occurrence of magnetic saturation.

### TECHNICAL FIELD

The present invention relates generally to a core for a transformer or a reactor. More particularly, the present invention relates to a core for a transformer or a reactor, the core provided by laminating a plurality of steel plates on top of each other and configured to form a magnetic path for a magnetic flux generated by a current applied to a coil.

### BACKGROUND ART

For example, in a transformer, when a current flows through a primary-side coil wound around a leg of a core, a magnetic flux is generated, and thereby, an electromotive force is induced in the direction of preventing the change of the magnetic flux in a secondary-side coil.

Generally, in order to increase the efficiency of a transformer, high magnetic permeability silicon steel plates having a relative permeability of thousands to tens of thousands are laminated to produce a core having a predetermined shape, wherein when a current flows into a coil wound on a leg of the core, DC magnetic flux is generated in the core in proportion to the applied direct current and the number of turns of the coil. However, the DC magnetic flux cannot generate an induced electromotive force through electromagnetic induction in the opposite-side coil, so there is no magnetic flux to offset the generated DC magnetic flux in the core, and the core is saturated. Also in a reactor, since the core is saturated because there is no opposite-side coil to offset the alternating magnetic flux due to the alternating current of the coil, the core is saturated.

When the core is saturated as described above, the no-load loss becomes large and the temperature rises, whereby the insulator provided adjacent to the core of the transformer or the reactor is deteriorated and the dielectric breakdown may occur.

To solve the above problem, in a converter transformer or reactor in which a direct current flows, the same is designed with a low magnetic flux density to prevent saturation of the core, or an air gap is formed in the core. However, when designing a converter transformer or reactor with a low magnetic flux density, the size of the core becomes large and the size of the transformer or the reactor becomes large accordingly.

Regarding the formation of air gap in the core, it is disclosed in Korean Patent No. 10-0664898. If the air gap is in the core, the magnetic reluctance is much larger in the air gap than in the core, so it is possible to prevent direct current from being introduced into the coil, or prevent saturation of the core in the reactor without the opposite-side coil. However, when the air gap is formed, noise and vibration are largely generated due to the electromagnetic force of the core at opposite ends of the air gap, and additional structures are required to maintain the air gap.

In the above document of prior art, although the above problem is solved by providing a partial air gap in the core, in order to form an air gap partially, the air gap must be formed in the steel plate constituting the core, so that the process of manufacturing the core is complicated.

### DISCLOSURE

### Technical Problem

Accordingly, the present invention has been made keeping in mind the above problems occurring in the prior art, and an object of the present invention is to provide a core for a transformer or a reactor, in which magnetic saturation is prevented from occurring even though a direct current is mixed.

Another object of the present invention is to provide a core for a transformer or a reactor, the core having a compact size while preventing magnetic saturation from occurring.

### Technical Solution

In order to accomplish the above object, according to one aspect of the present invention, there is provided a core for a transformer or a reactor, the core including: at least two legs provided by laminating at least one of widthwise rolled steel plates and non-oriented steel plates on top of each other, and arranged in parallel to each other with a coil wound therearound; a first yoke configured to connect first ends of the legs to pass a magnetic flux between the legs; and a second yoke configured to connect second ends of the legs to pass a magnetic flux between the legs.

The legs include may include: a first leg with a first coil wound therearound; and a second leg arranged in parallel to the first leg, with a second coil wound therearound.

The legs include may include: a first leg with a first coil wound therearound; a second leg arranged in parallel to the first leg, with a second coil wound therearound; and a third leg arranged in parallel to the second leg, with a third coil wound therearound.

A length of each of the legs may have a predetermined value, and a length of each of the yokes corresponding to a distance between the legs may be formed to be shorter than the length of the legs.

Each of the first yoke and the second yoke may be made of at least one of non-oriented steel plates, widthwise steel plates, and lengthwise steel plates.

According to another aspect of the present invention, there is provided a core for a transformer or a reactor, the core including: at least two legs provided by laminating steel plates and non-oriented steel plates on top of each other, and arranged in parallel to each other with a coil wound therearound; a first yoke configured to connect first ends of the legs to pass a magnetic flux between the legs; and a second yoke configured to connect second ends of the legs to pass a magnetic flux between the legs, wherein at least one of the legs, the first yoke, and the second yoke is made of widthwise rolled steel plates or non-oriented steel plates, and remainder is made of at least one of widthwise rolled steel plates, non-oriented steel plates, and lengthwise rolled steel plates.

A length of each of the legs may have a predetermined value, and a length of each of the yokes corresponding to a distance between the legs may be formed to be shorter than the length of the legs.

### Advantageous Effects

According to the present invention having the above-described characteristics, the advantageous effects of the present invention are as follows.

In the core according to the present invention, since widthwise rolled steel plates or non-oriented steel plates are used for a leg or a yoke with a coil wound therearound to increase the magnetic reluctance, magnetic saturation does not occur even if DC is supplied to the coil because the magnetic reluctance of the core is increased.

Further, in the present invention, since no additional process is required other than producing the steel plate used in manufacturing the core and making the same into a predetermined shape, and no additional structure is needed, the manufacturing process is simplified, and since there is no empty space like an air gap in the core, there is no noise or vibration caused by electromagnetic force.

Further, in the present invention, the length of the yoke is shorter than that of the leg of the core. In particular, the length of the yoke is determined within a range in which the insulation distance between the coils wound around the legs can be ensured, whereby it is possible to downsize the configuration of the transformer totally.

### DESCRIPTION OF DRAWINGS

FIG. 1 is a partial perspective view showing a configuration of a preferred embodiment of a core for a transformer or a reactor according to the present invention;

FIG. 2 is a plan view showing a state where a coil is wound around the core according to the embodiment shown in FIG. 1;

FIG. 3 is a B-H curve showing the characteristics of steel plates used in the core;

FIG. 4 is a partial perspective view showing a configuration of another embodiment of the present invention;

FIG. 5 is a plan view showing a state where a coil is wound around the core according to the embodiment shown in FIG. 4; and

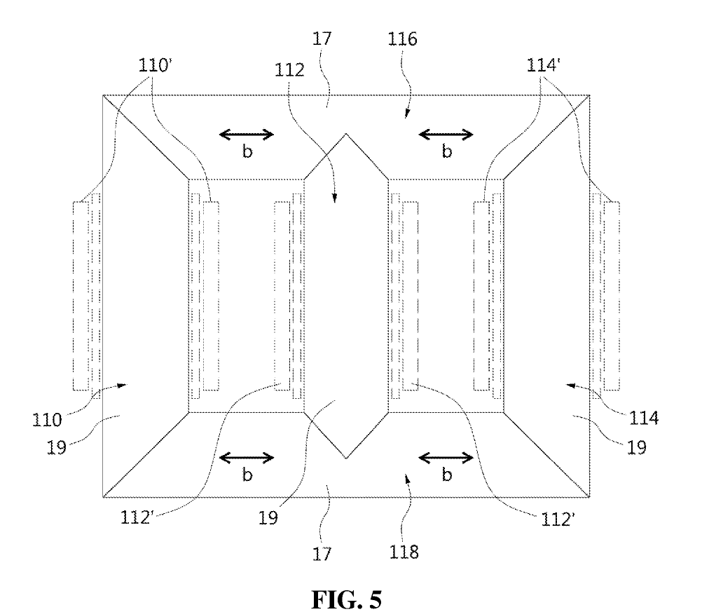

FIG. 6 is a partial perspective view showing a configuration of a further embodiment of the present invention.

### MODE FOR INVENTION

Reference will now be made in greater detail to an exemplary embodiment of the present invention, an example of which is illustrated in the accompanying drawings. Wherever possible, the same reference numerals will be used throughout the drawings and the description to refer to the same or like parts. Further, in the following description of the invention, if the related known functions or specific instructions on configuring the gist of the present invention unnecessarily obscure the gist of the invention, the detailed description thereof will be omitted.

Further, it will be understood that, although the terms first, second, A, B, (a), (b), etc. may be used herein to describe various elements, these elements should not be limited by these terms. These terms are only used to distinguish one element, from another element. It will be understood that when an element is referred to as being “coupled” or “connected” to another element, it can be directly coupled or connected to the other element or intervening elements may be present therebetween. In contrast, it should be understood that when an element is referred to as being “directly coupled” or “directly connected” to another element, there are no intervening elements present.

The purpose of the present invention is to prevent magnetic saturation from occurring in a reactor using an alternating current or a transformer into which an alternating current mixed with direct current flows. To achieve this, a core for a transformer or a reactor is designed by increasing the magnetic reluctance.

Generally, a current value I is represented by I=Hl/N (Equation 1) using a magnetic field intensity H, the number of coils N, and a magnetic path length 1. A magnetic flux density B is represented by B=NI/RS (Equation 2) using the number of coils N, a current I, a magnetic path cross-sectional area S, and a magnetic reluctance R. A relative permeability μᵣ is determined by the following equation using a magnetic flux density B, a magnetic field intensity H, and a magnetic permeability μ₀. That is, μᵣ=B/μ₀H (Equation 3).

Using the above equations, the magnetic reluctance can be obtained by R=1/μ₀μᵣS (Equation 4).

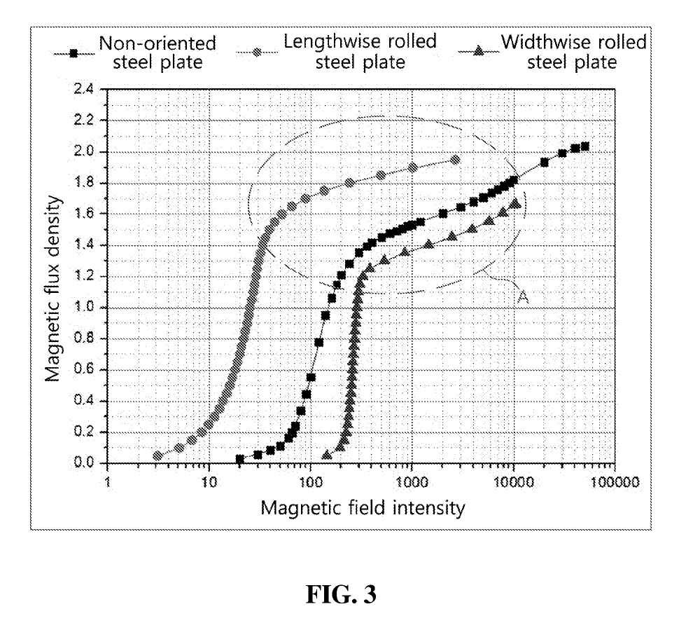

Herein, since the magnetic path cross-sectional area S and the magnetic path length 1 can be determined according to the design conditions, the magnitude of the magnetic reluctance R may be varied depending on the relative permeability μᵣ. In other words, the smaller the relative permeability μᵣ is, the greater the magnetic reluctance is. According to Equation 3, the relative permeability μᵣ is determined by the B/H value. Referring to a graph shown in FIG. 3, it is understood that the relative permeability μᵣ of non-oriented steel plate or widthwise rolled steel plate is smaller than that of lengthwise steel plate. When comparing the non-oriented steel plate and the widthwise rolled steel plate, it is understood that the relative permeability of the widthwise rolled steel plate is smaller than that of the non-oriented steel plate. Accordingly, using widthwise rolled steel plate or non-oriented steel plate rather than lengthwise steel plate can increase the magnetic reluctance R, thereby preventing the magnetic saturation of the core for a transformer or a reactor into which an alternating current mixed with direct current flows.

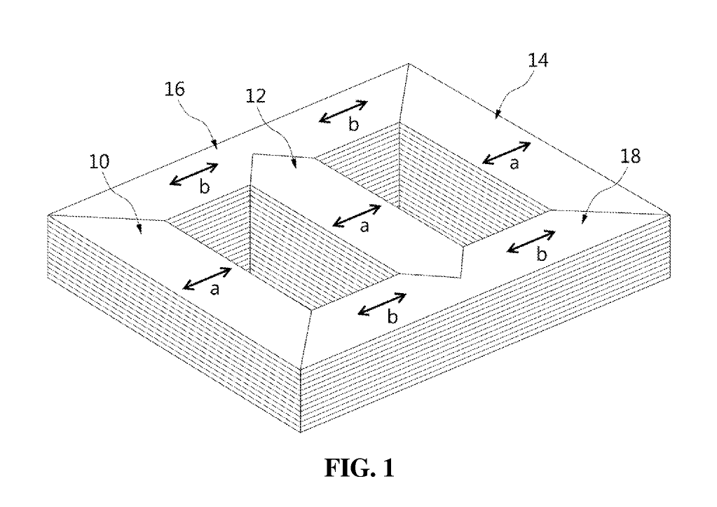

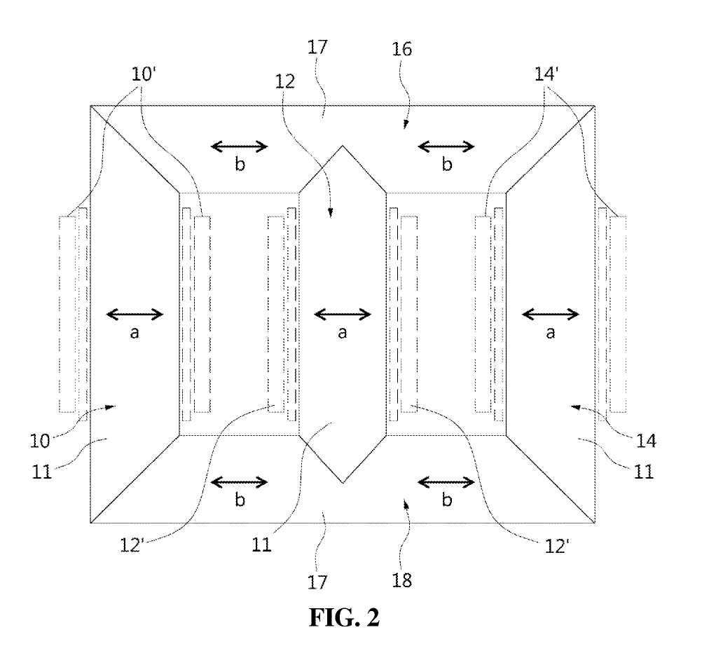

Meanwhile, detailed embodiments of the present invention will be described with reference to the accompanying drawings. Firstly, reference will be made to an embodiment shown in FIGS. 1 and 2. The core of the embodiment includes: a first leg 10, a second leg 12, and a third leg 14 arranged in parallel to each other; a first yoke 16 connecting first ends of the first leg 10, the second leg 12, and the third leg 14; and a second yoke 18 connecting second ends of the first leg 10, the second leg 12, and the third leg 14. Each of the legs 10, 12, and 14 and the yokes 16 and 18 is provided by laminating a plurality of steel plates on top of each other.

Further, a first coil 10′ including primary and secondary sides is wound around the first leg 10, a second coil 12′ including primary and secondary sides is wound around the second leg 12, and a third coil 14′ including primary and secondary sides is wound around the third leg 14. When a current is applied to the primary sides or the secondary sides of the coils 10′, 12′, and 14′, a current is generated on the secondary sides or the primary sides through the generated magnetic field.

The core is provided by laminating a plurality of steel plates, for example, silicon steel plates on top of each other. In the embodiment, all of the first leg 10, the second leg 12, and the third leg 14 are provided by laminating widthwise rolled steel plates 11. Herein, in the widthwise rolled steel plates 11, the rolling direction of the steel plates is the width direction of the first leg 10, the second leg 12, and the third leg 14. In other words, in making steel plates by rolling, the widthwise rolled steel plates 11 are rolled in the width direction as indicated by arrow a in FIG. 1 or 2.

Further, the first yoke 16 and the second yoke 18 are made by using lengthwise rolled steel plates 17 rolled in the longitudinal direction as indicated by arrow b in FIG. 1 or 2. The first yoke 16 and the second yoke 18 allow the magnetic flux to easily pass between the legs 10, 12, and 14. For reference, in a conventional core, legs and yokes are made by using lengthwise rolled steel plates.

Herein, the characteristics of the widthwise rolled steel plate 11, the lengthwise rolled steel plate 17, and the non-oriented steel plate 19 will be described with reference to FIG. 3. The characteristic curve associated with the widthwise rolled steel plate 11 is a curve connecting triangles, the characteristic curve associated with the lengthwise rolled steel plate 17 is a curve connecting circles, and the characteristic curve associated with the non-oriented steel plate 19 is a curve connecting squares.

For reference, in a region having a large slope value and having a slope lowered in the characteristic curve of the lengthwise rolled steel plate, that is, in a magnetic saturation region, area A, indicated by a dotted circle in FIG. 3, the lengthwise rolled steel plate cannot be used as a steel plate of a transformer. In other words, in a region having a very large slope before the above region, the lengthwise rolled steel plate is used as a steel plate of a transformer.

Herein, referring to the characteristic curves of the widthwise rolled steel plate 11 and the non-oriented steel plate 19, generally, the slope is large in the region where the magnetic field intensity H is larger than that in the characteristic curve of the lengthwise rolled steel plate 17. In other words, in the case of the widthwise rolled steel plate 11, the magnetic field intensity is in the range of 200 to 300 [A/m], and in the case of the non-oriented steel plate 19, the magnetic field intensity is in the range of 100 to 200 [A/m]. On the other hand, in the case of the lengthwise rolled steel plate 17, the magnetic field intensity is in the range of 10 to 30 [A/m].

Accordingly, using the widthwise rolled steel plate 11 and the non-oriented steel plate 19 rather than using the lengthwise rolled steel plate 17 can increase the magnetic reluctance of the core. Accordingly, even though the magnetic field intensity is increased due to inclusion of direct current, when the widthwise rolled steel plate 11 and the non-oriented steel plate 19 are used, it is possible to sufficiently accommodate.

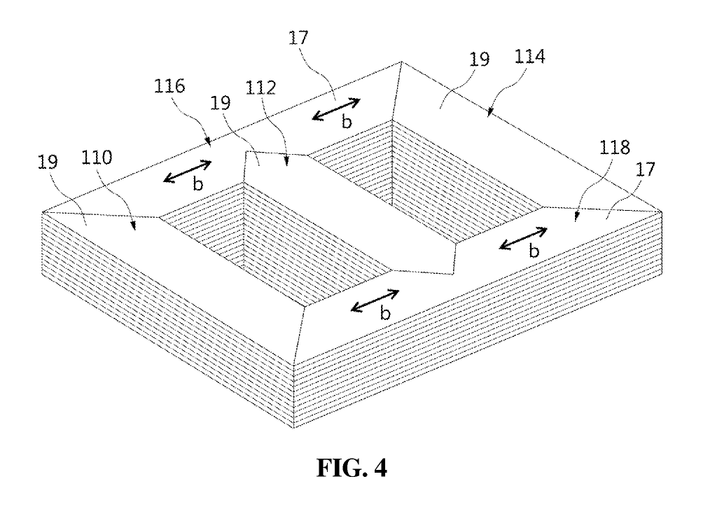

Next, FIG. 4 shows another embodiment of the present invention. The core of the embodiment includes: a first leg 110, a second leg 112, and a third leg 114 arranged in parallel to each other; a first yoke 116 connecting first ends of the first leg 110, the second leg 112, and the third leg 114; and a second yoke 118 connecting second ends of the first leg 110, the second leg 112, and the third leg 114. Each of the legs 110, 112, and 114 and the yokes 116 and 118 is provided by laminating a plurality of steel plates on top of each other.

In the embodiment, the non-oriented steel plates 19 are used in the first leg 110, the second leg 112, and the third leg 114. The lengthwise rolled steel plates 17 are used in the first yoke 116 and the second yoke 118 as in the above embodiment.

Further, a first coil 110′ including primary and secondary sides is wound around the first leg 110, a second coil 112′ including primary and secondary sides is wound around the second leg 112, and a third coil 114′ including primary and secondary sides is wound around the third leg 114. When a current is applied to the primary sides or the secondary sides of the coils 110′, 112′, and 114′, a current is generated on the secondary sides or the primary sides through the generated magnetic field.

In the embodiment, the non-oriented steel plates 19 are used, which means a steel plate without a rolling direction. Accordingly, in the drawing of the embodiment, the non-oriented steel plates 19 do not have an arrow mark.

As described above, in the embodiment, the non-oriented steel plates 19 are used in the first, second, and the third legs 110, 112, and 114. As can be seen in FIG. 3, the non-oriented steel plates 19 have characteristics corresponding to the midway between lengthwise rolled steel plates 17 and widthwise rolled steel plates 11 in terms of magnetic field intensity. Accordingly, the magnetic reluctance may be low compared to the embodiment shown in FIG. 1.

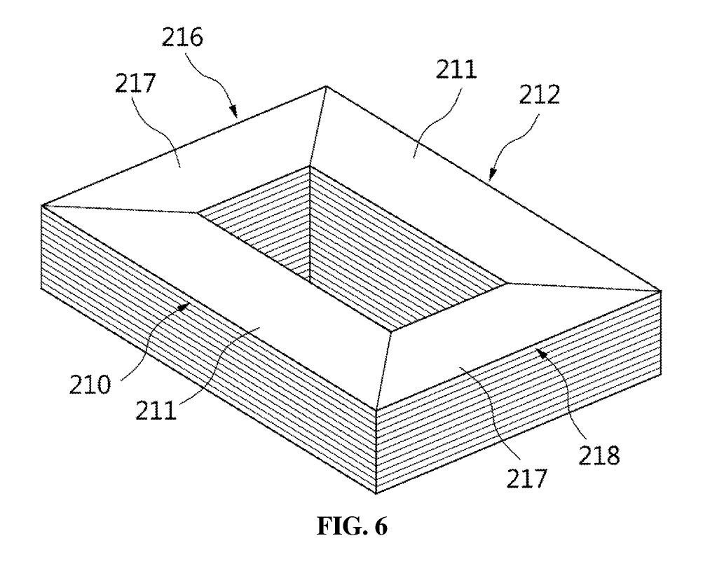

Meanwhile, in the above embodiments, the core is constituted by three legs 10, 12, and 14, 110, 112, and 114 and two yokes 16 and 18, 116 and 118, but in FIG. 6, the core is constituted by two legs 210 and 212, and two yokes 216 and 218, and the length of the legs 210 and 212 is longer than that of the yokes 216 and 218. This length relationship is the same in the two embodiments of the above. Of course, in the above embodiments, the length of the yokes 16 and 18, 116 and 118 refers to the value between the first leg 10 and the second leg 12 and between the second leg 12 and the third leg 14.

In the embodiment, of the two legs 210 and 212, each of the first leg 210 and the second leg 212 is made by using lengthwise rolled steel plates 211. Of the two yokes 216 and 218, each of the first yoke 216 and the second yoke 218 is made by using non-oriented steel plates 217. Herein, as described above, the non-oriented steel plate 217 used in the yokes 216 and 218 may have a larger magnetic reluctance than the lengthwise rolled steel plate 211. Accordingly, it is possible to increase the magnetic reluctance value than the case where the lengthwise rolled steel plates is used in all of the legs 210 and 212 and the yokes 216 and 218, whereby the function of the transformer can be performed without magnetic saturation even if direct current is continuously applied. In the embodiment, it is not described that a coil (not shown) is wound around the legs 210 and 212.

Hereinbelow, use of the core for a transformer or a reactor according to present invention configured as described above will be described.

Firstly, reference will be made to the embodiment shown in FIG. 1. In the core of the embodiment, the first coil 10′ is wound around the first leg 10, the second coil 12′ is wound around the second leg 12, and the third coil 14′ is wound around the third leg 14. The first yoke 16 and the second yoke 18 allow the magnetic flux to easily pass between the legs 10, 12, and 14. Herein, since the first yoke 16 and the second yoke 18 are made by using the lengthwise rolled steel plates 17, and the first leg 10 and the second leg 12 are made by using the widthwise rolled steel plates 11, the magnetic reluctance value becomes large in terms of the overall magnetic reluctance, and magnetic saturation does not occur even though a direct current is mixed.

In the above configuration, for example, when a current is applied to the primary sides or the secondary sides of the coils 10′, 12′, and 14′, a magnetic field is generated, and the magnetic flux due to the magnetic field flows through the legs 10, 12, and 14, and the yokes 16 and 18, whereby a voltage is generated on the secondary sides or the primary sides of the coils 10′, 12′, and 14′, and the current flows.

Meanwhile, in the embodiment shown in FIG. 4, the legs 110, 112, and 114 are made of the non-oriented steel plates 19, and the yokes 116 and 118 are made of the lengthwise rolled steel plates 17. Accordingly, the overall magnetic reluctance value is large compared to the case where only the lengthwise rolled steel plates 17 are used, so magnetic saturation does not occur even though a direct current is mixed.

Although a preferred embodiment of the present invention has been described for illustrative purposes, those skilled in the art will appreciate that various modifications, additions and substitutions are possible, without departing from the scope and spirit of the invention as disclosed in the accompanying claims. Thus, the embodiment is therefore illustrative and not restrictive, since the scope of the invention is defined by the appended claims rather than by the description preceding them, and all changes that fall within meets and bounds of the claims, or equivalence of such meets and bounds are therefore intended to be embraced by the claims.

In the embodiments, the case of the three legs 10, 12, and 14 and the case of the two legs 210 and 212 are shown, but there may be cores having a plurality of legs such as five legs while having an entire plane in a quadrangular shape.

Further, in one of the embodiments, the legs 10, 12, and 14 are made of the widthwise rolled steel plates 11, and the other embodiment, the non-oriented steel plates 19 are used in the same, but the widthwise rolled steel plates and the non-oriented steel plates may be mixed with each other. Various combinations are possible, for example, the first leg 10 may be made of the widthwise rolled steel plates 11, the second leg 10 may be made of the non-oriented steel plates 19, and the third leg 10 be made of the widthwise rolled steel plates 11. In other words, the core may be configured such that at least one of the legs and yokes is made of widthwise rolled steel plates or non-oriented steel plates, and the remaining legs and yokes are made of at least one of widthwise rolled steel plates, non-oriented steel plates, and lengthwise rolled steel plates.

1. A core for a transformer or a reactor, the core comprising:
at least two legs provided by laminating at least one of widthwise rolled steel plates and non-oriented steel plates on top of each other, and arranged in parallel to each other with a coil wound therearound;
a first yoke configured to connect first ends of the legs to pass a magnetic flux between the legs; and
a second yoke configured to connect second ends of the legs to pass a magnetic flux between the legs.

2. The core of claim 1, wherein the legs include:
a first leg with a first coil wound therearound; and
a second leg arranged in parallel to the first leg, with a second coil wound therearound.

3. The core of claim 1, wherein the legs include:
a first leg with a first coil wound therearound;
a second leg arranged in parallel to the first leg, with a second coil wound therearound; and
a third leg arranged in parallel to the second leg, with a third coil wound therearound.

4. The core of claim 1, wherein a length of each of the legs has a predetermined value, and a length of each of the yokes corresponding to a distance between the legs is formed to be shorter than the length of the legs.

5. The core of claim 1, wherein each of the first yoke and the second yoke is made of at least one of non-oriented steel plates, widthwise steel plates, and lengthwise steel plates.

6. A core for a transformer or a reactor, the core comprising:
at least two legs provided by laminating steel plates and non-oriented steel plates on top of each other, and arranged in parallel to each other with a coil wound therearound;
a first yoke configured to connect first ends of the legs to pass a magnetic flux between the legs; and
a second yoke configured to connect second ends of the legs to pass a magnetic flux between the legs,
wherein at least one of the legs, the first yoke, and the second yoke is made of widthwise rolled steel plates or non-oriented steel plates, and remainder is made of at least one of widthwise rolled steel plates, non-oriented steel plates, and lengthwise rolled steel plates.

7. The core of claim 6, wherein a length of each of the legs has a predetermined value, and a length of each of the yokes corresponding to a distance between the legs are formed to be shorter than the length of the legs.
